(19) United States
(12) Patent Application Publication
(10) Pub. No.: US 2002/0179350 A1
(43) Pub. Date: Dec. 5, 2002

(54) Multi-power electric environmental protection automobile

(76) Inventor: Chuguan Li, Shenzhen (CN)

Correspondence Address: LARSON & TAYLOR, PLC, 1199 NORTH FAIRFAX STREET, SUITE 900, ALEXANDRIA, VA, 22314, US

(21) Appl. No.: 09/871,594

(22) Filed: May 31, 2001

(51) Int. Cl. B60L 8/00

(52) U.S. Cl. 180/65.3; 180/14.1

(57) ABSTRACT

Disclosed is a multi-power electric environmental protection automobile, comprising a internal combustion engine, a battery power system, a power converter, and a universal. The internal combustion engine power system comprises the coupling of the engine, clutch, and transmission. The first input end of the power converter is connected to the output end of the transmission; the second input end of the power converter is connected to the output end of the battery power system; and the output end of the power converter is connected to the input end of the main reducer. The invention can effectively reduce pollution and make the automobile run long enough after charging. The logical location and structure of the power converter in the present invention make the automobile with multi-power systems of internal combustion engine and battery power to be really realized.

### FIELD OF THE INVENTION

The present invention relates to a motor vehicle, and more particularly to a vehicle selectively powered by an electric motor and an internal combustion engine.

### BACKGROUND OF THE INVENTION

It is beyond dispute that with the proliferation of the automobile there has been a resulting increase of pollutants in the form of automobile exhaust emissions. It is beyond question that these pollutants are destroying the environment. The greatest population density of automobiles are to be found in the densely populated urban areas and, it follows, that in such areas is the greatest auto pollution.

One approach to reduce or eliminate pollution has been the development of electric automobiles. Such vehicles, however, have significant disadvantages. Among them is that battery technology limits the range and speed of the vehicle and provides added significant weight.

Another approach has been automobiles which combine an internal combustion and electrically powered engines. By selectively switching between the electrically powered engine and an internal combustion engine there may be achieved a reduction or even the elimination of pollution. The electrically powered engine can be restricted to areas of expected high pollution and the internal combustion engine use in areas where pollution is generally low. Additionally, the internal combustion engine may be used to charge the batteries used to power the electric engine. Vehicles using these engine combination require a power converter to switch between the two engines. It is believed that previously proposed power converters are of a complex design and are physically large which has a complex construction which, in turn, provides unstable performance. Thus, proposed power converters are mounted within the auto chases which thereby causes the inappropriate and inefficient location of the electric motor. One example of this will be found in Chinese utility model ZL99211216.8.

FIGS. 1a, 1b, and 1c each disclose prior art typical chassis 30 of an automobile (not shown) upon which is mount an electrical motor/generator 7. Each chassis 30 is of well known construction with two parallel side rails 20, 32 between which are disposed the operational parts of the automobile such as a motor 3, a drive shaft 22, and a transmission 5 (the housing is diagrammatically shown) and a clutch 4.

In one embodiment (FIG. 1a) the motor/generator 7 is secured perpendicularly to side beam 20 of the automobile chassis. The motor/generator 7 is in this position because the distance between the prior art power converter 1 and the side rails 20, 32 is too narrow. This construction results in the raising upward of the auto body and the consequent displacement of the center of mass. This construction is, therefore, impractical.

In a second embodiment, FIG. 1b, the electrical motor/generator 7 is positioned parallel to and above chassis side rail 20 and to one side of the internal combustion engine 3. As a consequence of the space occupied by the engine 3, the electric motor/generator 7 cannot be mounted between the chassis side rails 20, 32. It has been found that this configuration does not, work in practical operation.

In the third embodiment, FIG. 1c, the electric motor/generator 7 is disposed parallel to the chassis side rail 20, and to one side of transmission 5. However, this installation requires an extended output shaft 21 from the motor/generator 7 to the clutch 4. The result is increase friction and an inherent instability caused by the asymmetrical installation.

FIG. 2 is a sectional view of the power converter of the aforementioned Chinese utility model ZL99211216.8. In this device the internal combustion engine power input shaft 10 of the power converter 1 is vertical to a battery power input shaft 11. In this setting, the electric motor/generator 7 may only be vertical to the chassis side rails 20, 32, which is believed to be inoperable in practical use. Another disadvantage is that power converter 1 uses bevel gears 24. As a consequence it is believed that the converter will not operate reliably.

### SUMMARY OF THE INVENTION

It is an objective of the present invention to provide an automobile which has two sets of power systems—a gasoline internal combustion engine and a battery powered electric motor—that can effectively reduce pollution emitted from automobile.

It is an objective of the present invention to provide an automobile which has two sets of power systems in which the power converter is of such a compact size that the electric motor/generator and power converter may be efficiently disposed within the vehicle.

In accordance with the invention, there is provided a multi-powered environmentally friendly automobile, comprising a internal combustion engine power system, a battery power system, a power converter and a main reducer; The said internal combustion engine power system involves the orderly connected engine, clutch and transmission case; characterized in that, the first input end of said power converter is connected to the output of said transmission case, the second input end of said power converter is connected to the output of said battery power system, the output end of said power converter is connected to the input end of said main reducer.

In above mentioned multi-power electric environmental protection automobile, the existing technical scheme is thrown away in which the power converter is located tightly behind of the clutch that is connected to the output of the engine. The power converter is set between the transmission case of internal combustion engine power system and the main reducer; thus the battery power system can be laid reasonably on the automobile chassis and the scheme of the multi-power system automobile with internal combustion engine power system as well as battery power system can be really realized; and the big problem puzzling researchers in the field for a long time has been solved.

### BRIEF DESCRIPTION OF THE DRAWINGS

FIGS. 1a, 1b, and 1c are schematic diagrams of prior art dual powered systems installed on an automobile chassis;

FIG. 2 is a sectional view of a prior art power converter as disclosed in Chinese utility model ZL99211216.8.;

FIG. 3 is a schematic diagram of the dual engine automobile of this invention;

FIG. 4 is a schematic diagram of a second embodiment of the automobile of this invention; and

FIG. 5 is a sectional view of the power converter of this invention.

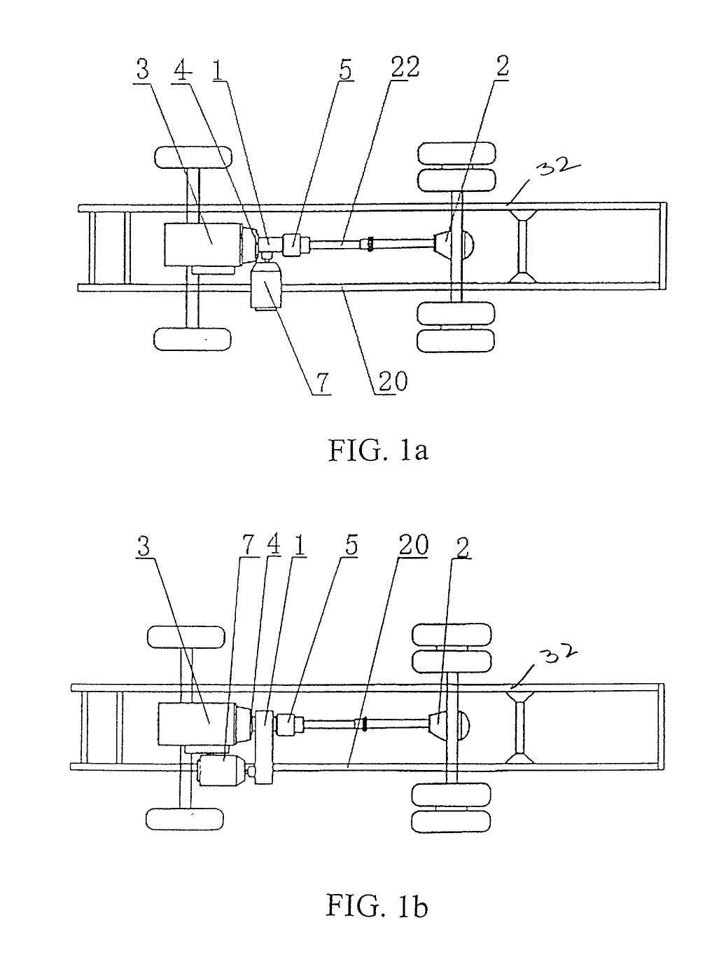

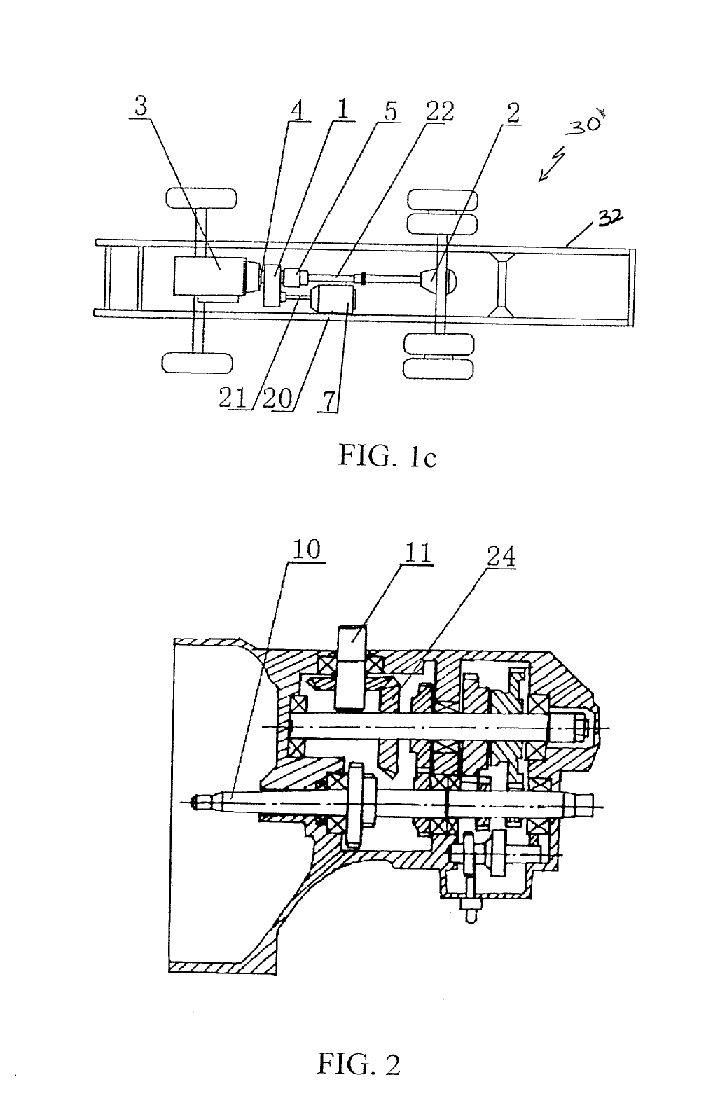

### DETAILED DESCRIPTION OF A PREFERRED EMBODIMENT[]

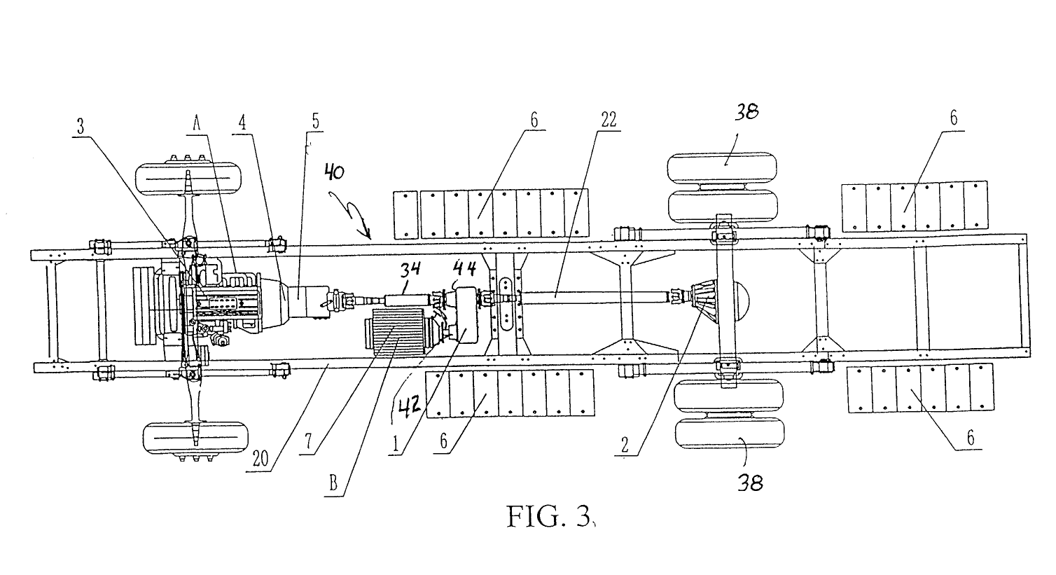

Turning the present invention, FIG. 3 shows a schematic diagram of a frame 40 of an automobile. Secured within the frame 40, in a manner well known in the art, is an internal combustion powered system A, an electrically powered system B, a power converter 1, and a power train 22 coupled to a differential 2. The internal combustion power system A includes an internal combustion engine 3, a clutch 44, and a transmission 5. A first input end of the power converter 1 is connected to the output of the transmission 5. A second input end of the power converter 1 is connected to the output of the electrically powered system B. The output of the power converter 1 is connected to the input end of the power train 22. The electrically powered system B includes groups of batteries 6, the electric motor/generator 7, and a controller which is well known in the art (not shown) which connects the batteries groups 6 to the electric motor/generator 7 to control the operation of the electric motor/generator 7. The electric motor/generator operates as an electric motor when driven by electric power and as a generator while driven by mechanical energy, as is well known in the art. The controller connects the batteries groups 6 to the electric motor/generator 7 and controls the operation of the electric motor/generator. The output of the electric motor/generator 7 is connected to the second input of the power converter 1. The controller may adjust the power and operation while the battery groups 6 are supplying power to the electric motor/generator 7 to power the automobile. The controller may also switch the electric motor/generator 7 to a generator mode and charge the battery groups 6 when surplus energy is provided by the internal combustion engine system A. Controllers of this nature are well known in the art and are not considered a part of this invention.

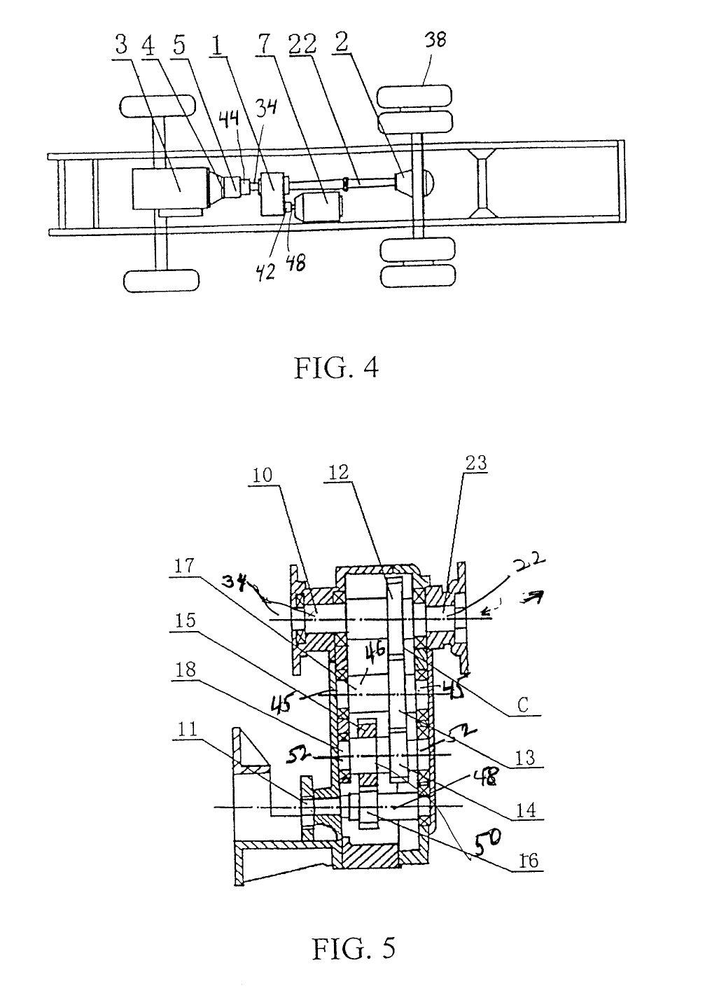

The power converter 1 is located between the transmission 5 of the internal combustion engine power system A and the power train 22. The electric motor/generator 7 may be mounted between the main transmission train 22 and the chassis side frame 20 of the automobile. In this way, the electric motor/generator 7 may be installed between the power converter 1 and the internal combustion engine 3 (FIG. 3) or between the power converter 1 and the universal 2 (FIG. 4). In this way, the automobile can have the center of gravity as a typical automobile. Consequently, an automobile with multi-power systems of internal combustion engine power system and electric power system becomes practical.

The power converter 1 of the present invention (FIG. 5) includes a race 10 for receiving the drive shaft 34 (FIG. 3) from the combustion engine 3. The electric motor/generator output shaft 36 connects to a race 11 of the power converter 1. One end of the shaft 34 is connected to the output of the transmission 5. The race 10 communicates and is coaxial with the output race 23. The drive train 22 is rotatable within race 23. The drive train 22 is in turn, is connected to the universal 2. The axes of the combustion engine input race 10 and the electric motor/generator input race 11 are parallel to each other and are connected through a transmission gear group C.

The arrangement of the gears in the power converter 1 of this invention are more compactly arranged so as to be able to fit within the confines of the chassis and permit the power train to be disposed in its central position along the main axis of the vehicle.

In this embodiment, the transmission gear group C includes gears 12, 13, 14, 15, and 16. The axis of gear 12 is coincident with the axis of the drive shaft 34 which is rotatably secured to the internal combustion race 10. The axis 17 of gear 13. Gears 14 and 15 rotate about axis 18. Gear 16 rotates the axis of the output shaft of the clutch 42 which is rotatably secured to the electric motor/generator input race 11. Axes 17 and 18 are parallel to the axis of drive shafts 34 and 42. Gear 12 meshes with gear 13. Gear 13 meshes with gear 14. Gear 15 meshes with gear 16. The diameter of gear 12 is greater than that of gear 13. The diameter of gear 13 is greater than that of gear 14. The diameter of gear 15 is greater than the diameter of gears 13, 14, 16. When an automobile is powered by the electric motor/generator 7, gears 12, 13, 14, 15, and 16 transfer power from of the electric motor/generator 7 to output race 23 and the power train 22 therein from power converter 1 and thence to the universal 2 to drive the wheels 38 of the automobile. When driving by the internal combustion engine power system A, the output power of internal combustion engine 3 is passed by the transmission 5 through a clutch 44 and rotatably connect by shaft 34 to the input race 10 of the power converter 1. The power converter 1 transmits the power to the universal 2 to drive the automobile. The two sets of power systems can operate either independently or simultaneously. They operate through the power converter 1. Gear 13 is rotatable upon a shaft 46 which, in turn is supported by races 45. Gears 14 and 15 are mounted parallel one another and secured to common shaft 50 and rotatable within races 52.

In the above-mentioned embodiment of the power converter 1, each axis of each gear is parallel to one another and all gears are cylindrical. In this way, the power transmission is reliable and stable. At the same time, the internal combustion engine power input race 10 is parallel to the battery power input axis 11. Thus, electric motor/generator input race 11. Thus, the electric motor/generator 7 can be disposed parallel to the transmission drive shaft 22, and between the side frames 20, 32 of the automobile chassis 40.

In operation, when the automobile is driven by the internal combustion engine power 3, part of the power output from the engine 3 is transmitted to the universal 2 by means of the drive shaft 22 connected to the output race 23 of the power converter 1. The remainder of the power passes from drive shaft 36 through race 11 and through the transmission gear group C and causes the input gear 16 to rotate thereby cause the electric motor/generator 7 to act as a generator and charge the battery groups 6 through the controller.

A clutch 42 may connect the output shaft 48 of the power converter 1 and the output of the clutch 42 may have an output shaft (not visible) rotatably connected to the second input race 11. When the clutch 42 is open, the power of the internal combustion engine 3 is used to drive the automobile. When the clutch 42 is engaged, there are two possible operating modes. First, the internal combustion engine power system A and the electric motor/generator power system B work together to drive the automobile. This first mode is preferable where the automobile is going at a relatively high speed and/or accelerating. Second, as stated before, when driving the automobile at a substantially constant velocity (or not accelerating at high speeds), the surplus energy of the internal combustion engine power A is used to recharge the electric motor/generator group B.

Between the first input end of the power converter 1 and output end of the internal combustion engine power system A, namely between the output end of the transmission 5 and the input race 10 of the power converter 1, the clutch 44. When using internal combustion engine power, the clutch 44 may be engaged; when using electrical power, the clutch 44 may be open, thus avoiding power passing into the transmission 5 causing friction and waste of power.

The present invention multi-power system provides the following advantages: It can turn off the internal combustion engine 3 and engage battery power driving when running in the heavily populated areas to reduce exhaust emission. It can engage internal combustion engine power to drive the automobile and operate effectively and economically while running in suburban areas or highways in which the automobile can run at an average speed and is out of any pollution control area. At the same time, the power of the internal combustion engine 3 can recharge the battery groups 6 by means of the electric motor/generator 7 to fully utilize the surplus energy and extend the distance of electric driving. In addition, the system permits the dual use of the electric motor/generator 7 to supplement the internal combustion engine when the power of the engine 3 provides inadequate power.

What is claimed is:

1. A power converter for a multi-powered system for an automobile; the multi-powered system being of the type having a drive train connected to a universal for driving the automobile wheels, an internal combustion engine and an electric motor and wherein the internal combustion engine power system further comprises an engine, a clutch, and a transmission; the power converter comprising:
a) first input end connected to the output of the transmission;
b) second input end connected to the output end of the electric motor; and
c) an output being connected to the input end of the universal.

2. The invention as recited in claim 1, further comprises a multiplicity of batteries; an electric motor having the capability to function as a electric motor when driven by electric power and as a generator when driven by mechanical energy, and a controller which is connected between said multiplicity of batteries and the electric motor/generator to control the operation of the electric motor/generator; an output end of the electric motor/generator being connected to the second input end of said power converter.

3. The invention as recited in claim 1, further comprises said power converter coupled to the internal combustion engine output and the electrical motor output; one end of the input of said power converter connected to the output of the transmission; the output of said power converter is connected to the drive train and universal; the axis of the two inputs are parallel; a gear train within said power converter for selectively combining the engine and electric motor output.

4. The invention as recited in claim 3, wherein said gear train comprises at least a first, second, third, fourth and fifth gears; said first gear is coaxial with the axis of said first input; said second gears rotates about a second axis, said third and fourth gears each rotate about a third axis; said fifth gear rotates about the axis of the second input; said axes of rotation are parallel one another; said first gear engages said second gear, said second gear engages said third gear, and said four gear engages said fifth gear.

5. The invention as recited in claim 4, further comprises that the diameter of said first gear is greater than the diameter of said second gear, the diameter of said second gear is greater than the diameter of said third gear, the diameter of said fourth gear is greater than the diameter of said third and fifth gears.

6. The invention as recited in claim 1, further comprises a first clutch coupled between said second input of said power converter and said output of said electric motor.

7. The invention as recited in claim 3, further comprises a second clutch coupled between said first input end of said power converter and said output of the transmission from said input from said engine.

8. The invention as recited in claim 4, further comprises said gears are cylindrical.

9. A power converter within a housing, the converter being of the type used with dual propulsion vehicles of the type including, for example, an internal combustion engine and an electric engine and a drive shaft for delivering power to propel the vehicle, the converter the comprising:
a) first and second input ports into the housing each for receiving the rotatable shafts delivering the output of the engines;
b) a third output port for connecting to the drive shaft;
c) a multiplicity of gears for connecting the output power of the engines to said third output port;
d) said input ports principle axes parallel one each other; and
e) said gears being disposed perpendicular to said principle axes.

10. A power converter as recited in claim 9 in which said gears are cylindrical.

11. A power converter as recited in claim 10 in which at least one of said gears is parallel to another of said gears.

12. A power converter as recited in claim 11 in which said gears are disposed in two parallel planes and two of said gears are parallel and coaxial and rotatably secured to a common shaft.

13. A power converter as recited in claim 12 further comprises three of said gears disposed within a first plane and engage one another; one of said gears being rotatable about and by the output shaft of the internal combustion engine.

14. A power converter as recited in claim 13 further comprises another two of said gears are disposed in a second plane; said first and second plane being parallel one another and one of said gears engaged by the output shaft of the electric engine.

15. The method of converting the battery powered electric engine and gasoline powered internal combustion engine within a single moving vehicle and in which each engine has an output rotatable shaft for providing motive power for the vehicle and a drive shaft for delivering the motive power to the vehicle wheels, said method of power converting comprising:
a) providing gears for transferring the power of each engine to the drive shaft;
b) aligning the gears in two planes; and
c) aligning the planes perpendicular to the axes of the shafts.

16. The method of claim 15 further comprises driving, by the gears, the electric engine with the internal combustion engine; charging the batteries by means of the internal combustion engine under predetermine conditions.

17. The method of claim 16 further comprises driving the vehicle with both the electric engine and the internal combustion engine upon predetermined conditions.

18. The method of claim 17 further comprises providing cylindrical gears.

19. The method of claim 18 further comprises providing three of the gears, each rotatable about a separate axle and in the same plane and engaging one another with one of the three gears providing power to the drive shaft.

20. The method of claim 19 further comprises providing a second set of two gears each rotatable upon an axle and one of the two gears rotatable axle in common with one of the set of three gears.

21. The method of claim 20 further comprises coupling the second of the two gears to the output of the electric engine shaft.
